(19) United States
(12) Patent Application Publication
(10) Pub. No.: US 2023/0065007 A1
(43) Pub. Date: Mar. 2, 2023

(54) ITEM CLASSIFICATION ASSISTANCE SYSTEM, METHOD, AND PROGRAM

(71) Applicant: NEC Corporation, Minato-ku, Tokyo (JP)

(72) Inventor: Masafumi OYAMADA, Tokyo (JP)

(73) Assignee: NEC Corporation, Minato-ku, Tokyo (JP)

(21) Appl. No.: 17/797,951

(22) PCT Filed: Feb. 25, 2020
(86) PCT No.: PCT/JP2020/007495

§ 371 Date: Aug. 5, 2022

(51) Int. Cl. G06F 40/279; G06F 40/268; G06F 40/242

(52) U.S. Cl. CPC G06F 40/279; G06F 40/268; G06F 40/242

(57) ABSTRACT

The acquiring unit which acquires for each item name, one or more words composing an item name from the item name belonging to a group including a plurality of item names, respectively. The computing unit which computes for each item name, relevance that is a degree to which the acquired word is related to the item name, respectively. The determination unit which determines words among the acquired words as candidates for a classification name of each item represented by the plurality of item names. The sum over the plurality of item names of the computed relevance of the determined word is up to the top Mth (M is a natural number).

### TECHNICAL FIELD

The present invention relates to an item classification assistance system, an item classification assistance method, and an item classification assistance program for assisting item classification.

### BACKGROUND ART

In some cases, data may be generated that relates a product to a classification name of a classification according to that product. FIG. 12 is a schematic diagram showing an example of data that relates a product to a classification name. The product is represented by a product name. In the example shown in FIG. 12, for example, a product with the product name “Great Detective C 1/10” is classified as “figure” and a product with the product name “Thief X poster” is classified as “poster”.

The data that relates the product to the classification name is used, for example, as teacher data in machine learning to forecast the demand for products.

The work of defining a classification name of a classification according to a product for the product is generally done manually for each product.

Patent Literature (PTL) 1 describes an information processing device that generates models for detecting data. The information processing device described in PTL 1 includes a classification means which sets a classification of target data based on the target data that satisfies predetermined conditions among data to be learned, and a model generating means which generates a model for detecting data based on the target data and the classification set for the target data.

In addition, PTL 2 describes an information processing device for e-commerce (Electronic Commerce), in which users purchase products via a communication network.

### CITATION LIST

### Patent Literature

PTL 1: International Publication No. WO 2019/187865
PTL 2: International Publication No. WO 2015/132886

### SUMMARY OF INVENTION

### Technical Problem

As mentioned above, the work of defining a classification name of a classification according to a product for the product is generally done manually for each product. Therefore, the work is very time-consuming.

In addition, it is desirable to be able to easily define the classification name of the classification according to the item, not only for products, but also for items other than products.

PTL 1 does not disclose the defining the classification name of the classification for the product.

In addition, PTL 2 discloses the defining the classification name of the classification for the product. Specifically, the information processing device described in PTL 2 extracts keywords representing attributes for each of a selected plurality of products, and selects at least one keyword that is common or similar among the extracted keywords in the plurality of products as a group word (classification name).

However, the range of candidates for classification names from which the user can select would be broader if attributes related to the plurality of products were selected as well as attributes common or similar to the plurality of products. The information processing device described in PTL 2 only assumes the selecting keywords that are common or similar to the plurality of products.

Therefore, it is an object of the present invention to provide an item classification assistance system, an item classification assistance method, and an item classification assistance program capable of presenting candidates for appropriate classification names of the classification for items to be classified to a user.

### Solution to Problem

An item classification assistance system according to the present invention is an item classification assistance system includes an acquiring means which acquires for each item name, one or more words composing an item name from the item name belonging to a group including a plurality of item names, respectively, a computing means which computes for each item name, relevance that is a degree to which the acquired word is related to the item name, respectively, and a determination means which determines words among the acquired words as candidates for a classification name of each item represented by the plurality of item names, wherein the sum over the plurality of item names of the computed relevance of the determined word is up to the top Mth (M is a natural number).

An item classification assistance method according to the present invention is an item classification assistance method, implemented by a computer, includes acquiring for each item name, one or more words composing an item name from the item name belonging to a group including a plurality of item names, respectively, computing for each item name, relevance that is a degree to which the acquired word is related to the item name, respectively, and determining words among the acquired words as candidates for a classification name of each item represented by the plurality of item names, wherein the sum over the plurality of item names of the computed relevance of the determined word is up to the top Mth.

An item classification assistance program according to the present invention, causing a computer to execute an acquisition process of acquiring for each item name, one or more words composing an item name from the item name belonging to a group including a plurality of item names, respectively, a computation process of computing for each item name, relevance that is a degree to which the acquired word is related to the item name, respectively, and a determination process of determining words among the acquired words as candidates for a classification name of each item represented by the plurality of item names, wherein the sum over the plurality of item names of the computed relevance of the determined word is up to the top Mth. The present invention may also be a computer-readable recording medium recording the above item classification assistance program.

### Advantageous Effects of Invention

According to the present invention, it is possible to present candidates for appropriate classification names of the classification for items to be classified to a user.

### BRIEF DESCRIPTION OF DRAWINGS

FIG. 1 is a block diagram showing an example of the configuration of an item classification assistance system of an example embodiment of the present invention.

FIG. 2 is a block diagram showing an example of the configuration of a classification name candidate determination unit 3.

FIG. 3 is an explanatory diagram showing an example of a word matrix generated by a word matrix generating unit 7.

FIG. 4 is an explanatory diagram showing an example of a word matrix corrected by a word matrix correcting unit 8.

FIG. 5 is an explanatory diagram showing an example of determining candidates for classification names extracted by a classification name candidate extraction unit 9.

FIG. 6 is an explanatory diagram showing an example of determining the weight of each word by the classification name candidate extraction unit 9.

FIG. 7 is an explanatory diagram showing another example of determining candidates for classification names extracted by the classification name candidate extraction unit 9.

FIG. 8 is an explanatory diagram showing an example of a screen displayed by a display control unit 4 on a display device 5.

FIG. 9 is a flowchart showing an example of the processing progress of an example embodiment of the present invention.

FIG. 10 is a schematic block diagram showing an example of the configuration of a computer for an item classification assistance system of an example embodiment of the present invention.

FIG. 11 is a block diagram showing an overview of an item classification assistance system according to the present invention.

FIG. 12 is a schematic diagram showing an example of data that relates a product to a classification name.

### DESCRIPTION OF EMBODIMENTS

Hereinafter, example embodiments of the present invention are described with reference to the drawings.

In the following description, the case in which the item to be classified is a product is used as an example, but the item to be classified is not limited to the product. The item may be a company, for example.

An item is represented by an item name. For example, if the item is a product, the product name corresponds to the item name. If the item is a company, the company name corresponds to the item name.

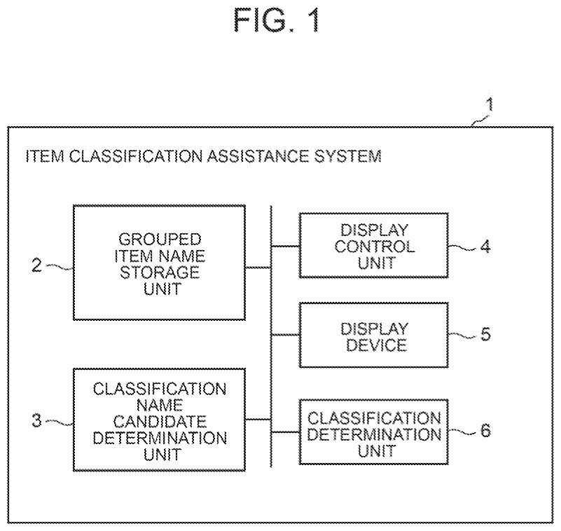

FIG. 1 is a block diagram showing an example of the configuration of an item classification assistance system of an example embodiment of the present invention. The item classification assistance system 1 of the example embodiment of the present invention includes a grouped item name storage unit 2, a classification name candidate determination unit 3, a display control unit 4, a display device 5, and a classification determination unit 6.

The grouped item name storage unit 2 is a storage device that stores the plurality of item names of items that have already been grouped. In this example, the grouped item name storage unit 2 stores the plurality of product names of products that have been grouped.

Specifically, the grouped item name storage unit 2 stores groups of product names for a set of product names (item names) of products (items).

A group of product names is a group consisting of, for example, one predetermined product name and one or more product names whose similarity to the predetermined product name is greater than or equal to a predetermined criterion. The similarity between two product names is, for example, “the reciprocal of the edit distance between two product names”. The groups may be determined by a method other than the above.

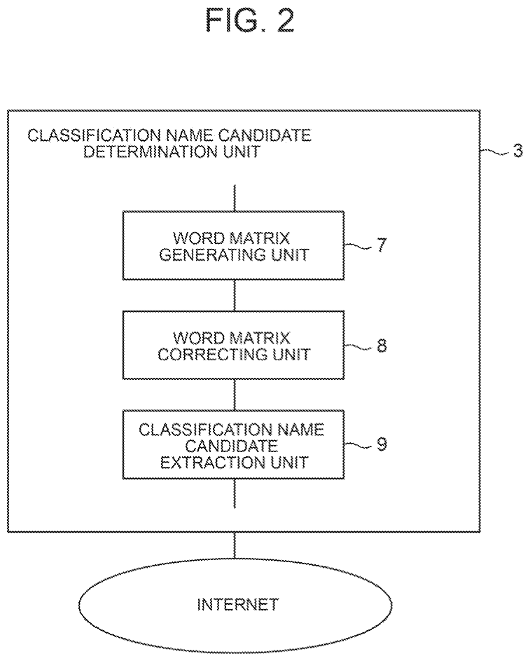

The classification name candidate determination unit 3 has the function of determining candidates for classification names for the products described above. FIG. 2 is a block diagram showing an example of the configuration of the classification name candidate determination unit 3.

As shown in FIG. 2, the classification name candidate determination unit 3 of this example embodiment includes a word matrix generating unit 7, a word matrix correcting unit 8, and a classification name candidate extraction unit 9. The classification name candidate determination unit 3 is connected to the Internet. The following is a description of the processing which the classification name candidate determination unit 3 of this example embodiment determines candidates for classification names for the product.

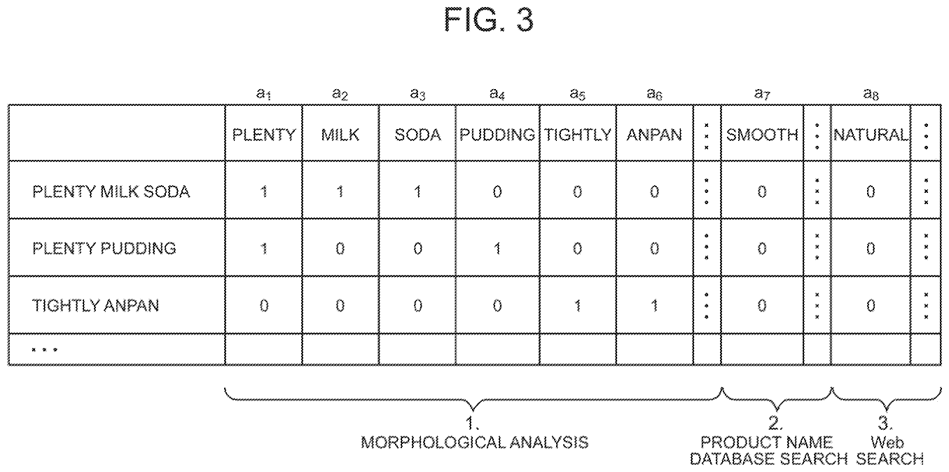

When one group stored in the grouped item name storage unit 2 is retrieved, the word matrix generating unit 7 of the classification name candidate determination unit 3 first generates a word matrix. FIG. 3 is an explanatory diagram showing an example of a word matrix generated by the word matrix generating unit 7.

First, the word matrix generating unit 7 stores in the first column of the word matrix each of the plurality of product names included in the retrieved group, as shown in FIG. 3. Examples of product names shown in FIG. 3 are “plenty milk soda,” “plenty pudding,” and “tightly anpan”. In this example, a total of 10 product names are included in the retrieved group.

The word matrix generating unit 7 performs morphological analysis on each product name stored in the word matrix as the first processing, respectively. When the word matrix generating unit 7 performs morphological analysis, each product name is divided into one or more words. For example, “plenty milk soda” is divided into the word “plenty,” the word “milk,” and the word “soda”.

Next, the word matrix generating unit 7 stores each word acquired by dividing each product name in the first row of the word matrix, as shown in FIG. 3. When the same word is acquired from the plurality of product names respectively, such as the word “plenty” shown in FIG. 3, the word matrix generating unit 7 stores only one acquired word.

In other words, the word matrix generating unit 7 acquires one or more words that compose the product name from the product name belonging to a group that includes the plurality of product names, for each product name, respectively.

The a₁, a₂, . . . shown in FIG. 3 are symbols that identify each word stored in the first row of the word matrix. For example, a₁ indicates the word “plenty”.

For each product name stored in the word matrix, the word matrix generating unit 7 performs a product name database search as the second processing.

The word matrix generating unit 7, for example, performs a product name database search using product names and extracts the attributes of the product names used in the search from the product name database.

The product name database is, for example, a database equipped in the store where the user works, in which product names and their attributes are stored in a searchable manner. The word matrix generating unit 7 connects to the product name database and searches for product names.

In this example, the word matrix generating unit 7 performed a product name database search using the product name “plenty pudding” and found that the attribute of “plenty pudding” is “smooth”. Therefore, as shown in FIG. 3, the word matrix generating unit 7 stores “smooth” in the first row of the word matrix.

If the product names are stored in the product name database by category, the word matrix generating unit 7 may extract words from the product name database that mean a higher concept (category) of the word used for the product name database search.

As words meaning a higher concept, the word matrix generating unit 7 may, for example, extract the word “bread,” which is a higher concept of “tightly anpan,” and the word “dairy products,” which is a higher concept of “plenty milk soda,” and store them in the word matrix.

The word matrix generating unit 7 performs the World Wide Web (hereafter simply referred to as the Web) search for each product name stored in the word matrix, as the third processing.

The word matrix generating unit 7, for example, performs a Web search using product names and extracts from the Web the words that are often associated with the product names used in the search.

In this example, the word matrix generating unit 7 performed a Web search using the product name “plenty milk soda” and found many words for “natural” on the Web. Therefore, as shown in FIG. 3, the word matrix generating unit 7 stores “natural” in the first row of the word matrix.

In other words, the word matrix generating unit 7 acquires words from outside (product name database or Web) that do not compose any of the plurality of product names and that are related to one of the plurality of product names.

Next, the word matrix generating unit 7 determines whether each word stored in the first row of the word matrix is included in each product name stored in the first column. If the word is included in the product name, the word matrix generating unit 7 sets the value of the component of the corresponding word matrix to “1”. If the word is not included in the product name, the word matrix generating unit 7 sets the value of the component of the corresponding word matrix to “0”.

For example, since the product name “plenty milk soda” includes the word “plenty”, the word matrix generating unit 7 sets the value of the (“plenty milk soda”, “plenty”) component of the word matrix to “1”. Also, since the product name “plenty milk soda” does not include the word “pudding,” the word matrix generating unit 7 sets the value of the (“plenty milk soda”, “pudding”) component of the word matrix to “0”.

After determining on all components of the word matrix, the word matrix generating unit 7 inputs the generated word matrix to the word matrix correcting unit 8. The word matrix correcting unit 8 has the function of correcting the values of the components of the input word matrix.

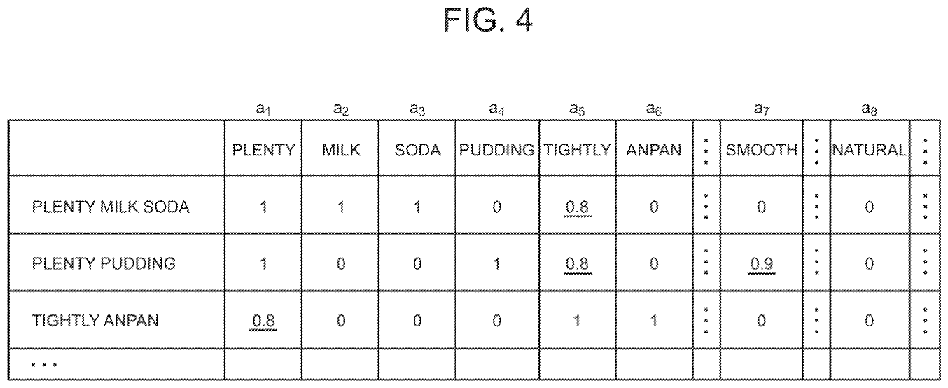

FIG. 4 is an explanatory diagram showing an example of a word matrix corrected by the word matrix correcting unit 8. The underlined values shown in FIG. 4 are the values of the components of the word matrix corrected by the word matrix correcting unit 8. The word matrix correcting unit 8 can correct the value of each component of the word matrix (especially “0”) based on any rule.

For example, since the attribute of “plenty pudding” was found to be “smooth” from the product name database, the word matrix correcting unit 8 may correct the value of the (“plenty pudding”, “smooth”) component to a value greater than 0. In the example shown in FIG. 4, the word matrix correcting unit 8 corrects the value of the (“plenty pudding”, “smooth”) component from “0” to “0.9”.

The word matrix correcting unit 8 may also correct based on the similarity between the plurality of words as defined in a dictionary held in advance. For example, if the dictionary defines that the word “plenty” and the word “tightly” are similar, the word matrix correcting unit 8 may correct the value of the (“tightly anpan”, “plenty”) component to a value greater than 0. In the example shown in FIG. 4, the word matrix correcting unit 8 corrects the value of the (“tightly anpan”, “plenty”) component from “0” to “0.8” because the value of the (“tightly anpan”, “tightly”) component is “1”.

For the same reason, the word matrix correcting unit 8 may correct the value of the (“plenty milk soda”, “tightly”) component and the value of the (“plenty pudding”, “tightly”) component both to values greater than 0.

In the example shown in FIG. 4, the word matrix correcting unit 8 corrects the value of the (“plenty milk soda”, “tightly”) component from “0” to “0.8” because the value of the (“plenty milk soda”, “plenty”) component is “1”. In addition, because the value of the (“plenty pudding”, “plenty”) component is “1”, the word matrix correcting unit 8 corrects the value of the (“plenty pudding”, “tightly”) component from “0” to “0.8”.

The word matrix correcting unit 8 can correct the values of the components of the word matrix by a variety of other ways. The word matrix correcting unit 8 may also convert the word matrix to a matrix with fewer components with a value of “0” by performing a low-rank approximation.

In the other words, the word matrix generating unit 7 and the word matrix correcting unit 8 compute the relevance, which is the degree to which the acquired words are related to the product name, for each product name, respectively. In particular, the word matrix generating unit 7 computes the relevance of words that compose a product name with that product name as 1, and the relevance of words that do not compose a product name with that product name as 0.

The word matrix correcting unit 8 may also compute the relevance based on the similarity between the plurality of words as defined in the dictionary held in advance.

The word matrix correcting unit 8 inputs the corrected word matrix to the classification name candidate extraction unit 9. The classification name candidate extraction unit 9 has the function of extracting candidates for classification names from the input word matrix. The classification name candidate extraction unit 9 of this example embodiment extracts candidates for classification names using one of the following two methods.

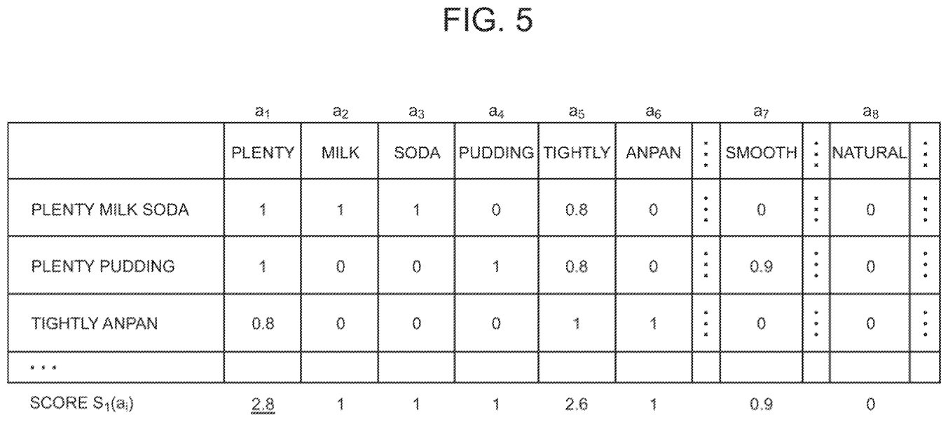

The first method is a method that simply determines candidates for classification names to be extracted based on the values of the components of the word matrix. FIG. 5 is an explanatory diagram showing an example of determining candidates for classification names extracted by the classification name candidate extraction unit 9.

The classification name candidate extraction unit 9 computes the score S₁(aᵢ) (i is a natural number), defined by the following formula, for each word aᵢ respectively.

S₁(aᵢ)=Σₙ₌₁^{N}(bᵢⁿ) Equation (1)

Note that bᵢⁿ in equation (1) is the value of the (i, n) component of the word matrix (n is a natural number between 1 and 10, and N=10). Each value under the word matrix shown in FIG. 5 is the score S₁(aᵢ) computed for each word aᵢ respectively.

Next, the classification name candidate extraction unit 9 determines the word with higher computed score among each word stored in the first row of the word matrix as the candidate for the classification name to be extracted. In the example shown in FIG. 5, the classification name candidate extraction unit 9 determines the word “plenty,” which has the highest computed score, as one of the candidates for the classification names to be extracted.

In other words, the classification name candidate extraction unit 9 determines words among the words acquired by the word matrix generating unit 7, as candidates for the classification names of each product represented by the plurality of product names. The sum over the plurality of product names of the relevance computed by the word matrix generating unit 7 and the word matrix correcting unit 8 of the determined word is up to the top Mth (M is a natural number).

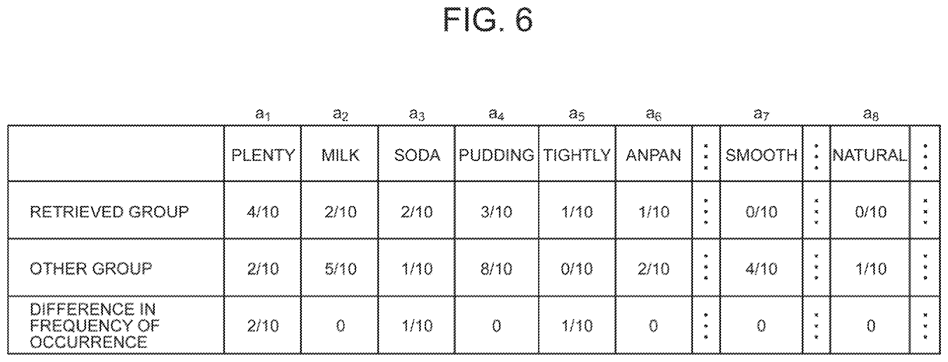

The second method is a method that also uses the weight, which is the relative importance of each word, to determine the candidates for the classification names to be extracted. FIG. 6 is an explanatory diagram showing an example of determining the weight of each word by the classification name candidate extraction unit 9.

In this example, the classification name candidate extraction unit 9 computes the frequency of occurrence of each word stored in the first row of the word matrix in 10 product names included in the retrieved group, as the second row of the matrix shown in FIG. 6, respectively.

For example, as shown in FIG. 6, the classification name candidate extraction unit 9 computes the frequency of occurrence of the word “plenty” in the retrieved group as “4/10”. The frequency of occurrence “4/10” means that the 10 product names include the 4 words “plenty”.

In addition, the classification name candidate extraction unit 9 computes the frequency of occurrence of each word stored in the first row of the word matrix in 10 product names included in the other group, as the third row of the matrix shown in FIG. 6, respectively.

For example, as shown in FIG. 6, the classification name candidate extraction unit 9 computes the frequency of occurrence of the word “plenty” in the other group as “2/10”. The frequency of occurrence “2/10” means that the 10 product names include the 2 words “plenty”.

The other group is a group consisting of 10 product names that are arbitrarily searched by product name database search, web search, or other methods. The 10 product names searched arbitrarily are product names that do not belong to the retrieved group.

In addition, the classification name candidate extraction unit 9 subtracts the frequency of occurrence in the other group from the frequency of occurrence in the retrieved group, as the fourth row of the matrix shown in FIG. 6, to compute the difference in the frequency of occurrence of each word stored in the first row of the word matrix, respectively.

For example, as shown in FIG. 6, the classification name candidate extraction unit 9 computes the difference in the frequency of occurrence of the word “plenty” as “(4/10−2/10=) 2/10”.

If the value obtained by subtracting the frequency of occurrence in the other group from the frequency of occurrence in the retrieved group is negative, the classification name candidate extraction unit 9 sets the difference in the frequency of occurrence to “0,” as shown in FIG. 6. For example, the difference in the frequency of occurrence of the word “milk” shown in FIG. 6 is set to “0” since (2/10-5/10)<0.

Next, the classification name candidate extraction unit 9 computes the score S₂(aᵢ), defined by the following formula, for each word aᵢ, respectively.

S₂(aᵢ)=Σₙ₌₁^{N}(wᵢ×bᵢⁿ) Equation (2)

Note that wᵢ in Equation (2) is a weight indicating the relative importance of the word aᵢ. The weight wᵢ in this example is the difference in the frequency of occurrence of the word aᵢ shown in FIG. 6. The classification name candidate extraction unit 9 may compute the weight wᵢ by the tf-idf method.

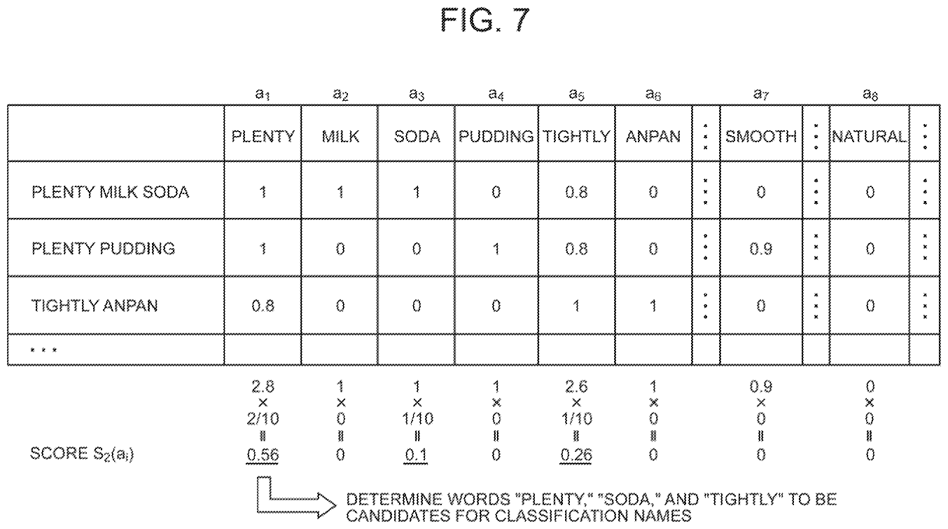

FIG. 7 is an explanatory diagram showing another example of determining candidates for classification names extracted by the classification name candidate extraction unit 9. Each computed value under the word matrix shown in FIG. 7 is the score S₂(aᵢ) computed for each word aᵢ respectively.

Next, the classification name candidate extraction unit 9 determines the word with the higher computed score among each word stored in the first row of the word matrix as the candidate for the classification name to be extracted. In the example shown in FIG. 7, the classification name candidate extraction unit 9 determines the words “plenty,” “soda,” and “tightly” that are in the top three in terms of computed score to be candidates for the extracted classification names.

In other words, the classification name candidate extraction unit 9 computes the weight of the word in the plurality of product names for each word, respectively. In addition, the classification name candidate extraction unit 9 determines words among the words acquired by the word matrix generating unit 7, as candidates for the classification names. The result that the sum over the plurality of item names of the relevance computed by the word matrix generating unit 7 and the word matrix correcting unit 8 of the determined word is weighted by the computed weights is up to the top Mth.

As in the example above, the classification name candidate extraction unit 9 may compute the weight of a word using the frequency of occurrence of the word in the plurality of product names and the frequency of occurrence of the word in an arbitrarily selected product name.

The classification name candidate determination unit 3 inputs candidates for classification names extracted by the classification name candidate extraction unit 9 to the display control unit 4. The display control unit 4 displays the inputted candidates for classification names on the display device 5 as candidates for classification names for each product represented by each product name belonging to the group.

The display device 5 is a device for displaying information and can be a common display device.

The operation of the display control unit 4 is described below. Here, we will focus on one group stored in the grouped item name storage unit 2 to describe. If the plurality of groups is stored in the grouped item name storage unit 2, the display control unit 4 should perform the same operation for each group.

The display control unit 4 displays the individual product names belonging to the group on the display device 5, and also displays the plurality of candidates for classification names for each product represented by each product name belonging to the group on the display device 5. At this time, the display control unit 4 displays the plurality of candidates of classification names on the display device 5 in a user-specifiable manner (e.g., a specifiable manner with a mouse click, etc.). The screen displayed on the display device 5 by the display control unit 4 may include other GUI (Graphical User Interface), etc.

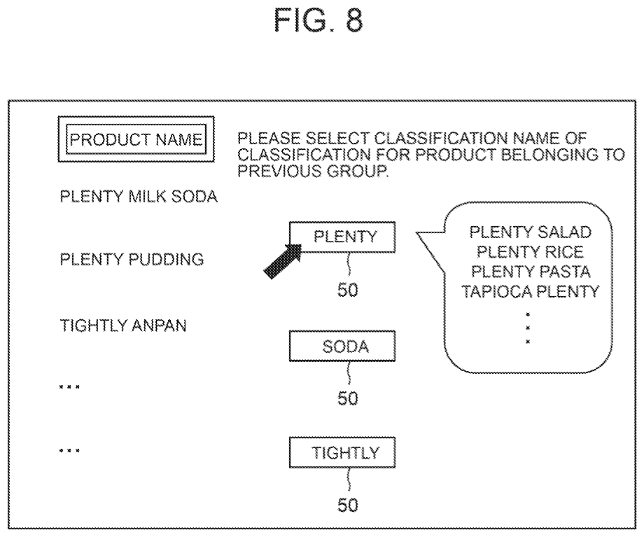

FIG. 8 is an explanatory diagram showing an example of a screen displayed by the display control unit 4 on the display device 5. The example shown in FIG. 8 shows a case in which the display control unit 4 displays the product names belonging to a group, such as “plenty milk soda,” “plenty pudding,” “tightly anpan,” and so on. The example shown in FIG. 8 also shows a case in which the display control unit 4 displays “plenty,” “soda,” and “tightly” as candidates 50 for classification names of each product represented by each product name. These candidates 50 can be specified by a mouse click or other operations by the user.

When one of the plurality of candidates 50 for the displayed classification names is specified by the user by a mouse click or other operation, the classification determination unit 6 determines that each product represented by each product name belonging to the group (i.e., each displayed product name) is classified by the classification name specified by the user. Then, the classification determination unit 6 generates data that relates each product name belonging to the group to the specified classification name.

For example, suppose that the user specifies the classification name “plenty” among each candidate 50 on the screen illustrated in FIG. 8. In this case, the classification determination unit 6 determines that each of the products represented by “plenty milk soda,” “plenty pudding,” and “tightly anpan” shown in FIG. 8 are classified under the classification name “plenty”. Then, the classification determination unit 6 generates data that relates each of “plenty milk soda,” “plenty pudding,” and “tightly anpan” to the classification name of “plenty”.

In other words, the display control unit 4 displays the plurality of product names and the plurality of candidates for classification names determined by the classification name candidate determination unit 3 for each product represented by the plurality of product names in a manner that allows the user to specify the names.

The display control unit 4 may also display the product name that includes the word that is a candidate for the classification name along with the candidate for the classification name. For example, as shown in FIG. 8, when the user moves the cursor over the candidate for the classification name on the screen, the display control unit 4 may display the product name that includes the word that is the candidate for the classification name next to the corresponding the candidate for the classification name.

Product names including words that are candidates for classification names are, for example, product names obtained through Web searches. The classification name candidate determination unit 3 inputs the product name including the word that is a candidate for the classification name to the display control unit 4.

By referring to product names other than each product name belonging to a group, the user may be more likely to decide on the final classification name to be wanted to use from among the plurality of candidates for classification names.

The classification name candidate determination unit 3, the display control unit 4, and the classification determination unit 6 are realized, for example, by a CPU (Central Processing Unit) of a computer that operates according to an item classification assistance program. For example, the CPU may read the item classification assistance program from a program recording medium such as a program storage device of the computer, and operate as the classification name candidate determination unit 3, the display control unit 4, and the classification determination unit 6 according to that item classification assistance program. The grouped item name storage unit 2 is realized, for example, by a storage device equipped in a computer.

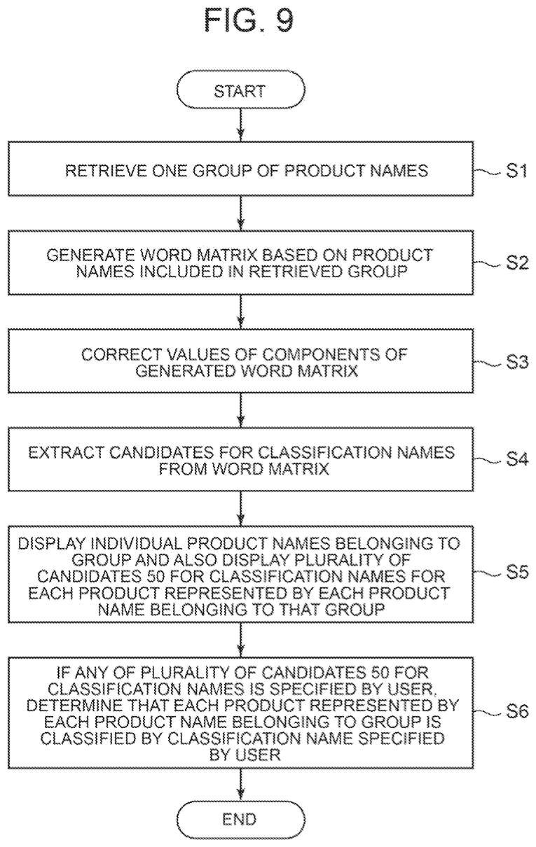

Next, the processing progress is described. FIG. 9 is a flowchart showing an example of the processing progress of an example embodiment of the present invention. Detailed explanations of matters already explained are omitted. The grouped item name storage unit 2 stores the product names of the products that have already been grouped together in advance.

First, the classification name candidate determination unit 3 retrieves one group of product names stored in the grouped item name storage unit 2 (step S1).

Next, the word matrix generating unit 7 of the classification name candidate determination unit 3 generates a word matrix based on the product names included in the retrieved group by performing morphological analysis, product name database search, and Web search, respectively (step S2). Note that the word matrix generating unit 7 does not need to perform the product name database search or the Web search in step S2.

Next, the word matrix correcting unit 8 corrects the values of the components of the word matrix generated by the word matrix generating unit 7 (step S3). The processing of step S3 may be omitted.

Next, the classification name candidate extraction unit 9 extracts candidates for classification names from the word matrix corrected by the word matrix correcting unit 8 (step S4). The classification name candidate determination unit 3 inputs the candidates for the classification names extracted by the classification name candidate extraction unit 9 to the display control unit 4.

Next, the display control unit 4 displays the individual product names belonging to the group on the display device 5, and also displays the plurality of candidates 50 for the classification names for each product represented by each product name belonging to the group (referring to FIG. 8, etc.) on the display device 5 (step S5).

In step S5, the display control unit 4 displays the plurality of candidates 50 for classification names on the display device 5 in a user-specifiable manner (e.g., a specifiable manner with a mouse click, etc.). The plurality of candidates 50 for classification names is a set of candidates for classification names input from the classification name candidate determination unit 3.

If any of the plurality of candidates 50 for classification names (referring to FIG. 8, etc.) is specified by the user, the classification determination unit 6 will determine that each product represented by each product name belonging to the group is classified by the classification name specified by the user (step S6). At this time, the classification determination unit 6 generates data that relates each product name belonging to the group to the specified classification name.

According to this example embodiment, the word matrix generating unit 7 acquires one or more words that compose the item name from the item name belonging to a group that includes the plurality of item names, for each item name, respectively. In addition, the word matrix generating unit 7 and the word matrix correcting unit 8 compute the relevance, which is the degree to which the acquired word is related to the item name, for each item name, respectively. The classification name candidate extraction unit 9 determines words among the acquired words as candidates for the classification names of each item represented by the plurality of item names. The sum over the plurality of item names of the computed relevance of the determined word is up to the top Mth.

Thus, the item classification assistance system 1 of this example embodiment can present to the user candidates for classification names that are highly related to the plurality of item names included in the group. Therefore, the item classification assistance system 1 can significantly reduce the burden on the user compared to the general method of manually defining classification names for each product. In addition, the item classification assistance system 1 can present more types of candidates for classification names to the user than the information processing device described in PTL 2.

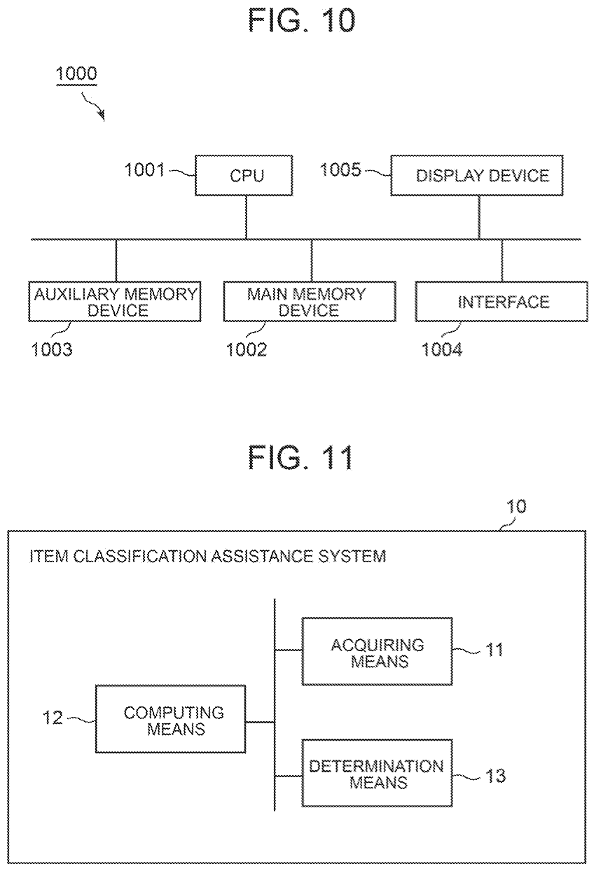

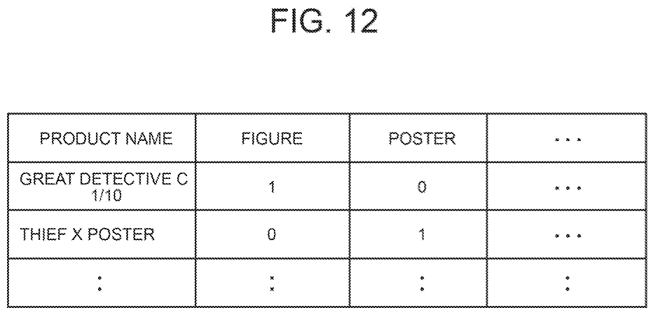

FIG. 10 is a schematic block diagram showing an example of the configuration of a computer for the item classification assistance system 1 of an example embodiment of the present invention. For example, the computer 1000 has a CPU 1001, a main memory device 1002, an auxiliary memory device 1003, an interface 1004, and a display device 1005.

The item classification assistance system 1 according to the example embodiment of the present invention is realized by the computer 1000. The operation of the item classification assistance system 1 is stored in the auxiliary memory device 1003 in the form of a program (an item classification assistance program). The CPU 1001 reads the program from the auxiliary memory device 1003, expands it to the main memory device 1002, and executes the processing described in the above example embodiment according to the program. In this case, the classification name candidate determination unit 3, the display control unit 4, and the classification determination unit 6 are realized by the CPU 1001. The display device 5 is realized by the display device 1005.

The auxiliary memory device 1003 is an example of a non-transitory tangible medium. Other examples of non-transitory tangible media are a magnetic disk, an optical magnetic disk, a CD-ROM (Compact Disk Read Only Memory), a DVD-ROM (Digital Versatile Disk Read Only Memory), a semiconductor memory, and the like, which are connected via the interface 1004. When the program is delivered to the computer 1000 via a communication line, the computer 1000 that receives the delivery may expand the program into the main memory device 1002 and execute the processing described in the above example embodiment according to the program.

Some or all of the components may be realized by general-purpose or dedicated circuitry, processors, or a combination of these. They may be configured by a single chip or by multiple chips connected via a bus. Some or all of the components may be realized by a combination of the above-mentioned circuits, etc. and a program.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

Next, an overview of the present invention will be explained. FIG. 11 is a block diagram showing an overview of an item classification assistance system according to the present invention. The item classification assistance system according to the present invention includes an acquiring means 11, a computing means 12, and a determination means 13.

The acquiring means 11 (for example, the word matrix generating unit 7) which acquires for each item name, one or more words composing an item name from the item name belonging to a group including a plurality of item names, respectively.

The computing means 12 (for example, the word matrix generating unit 7 and the word matrix correcting unit 8) which computes for each item name, relevance that is a degree to which the acquired word is related to the item name, respectively.

The determination means 13 (for example, the classification name candidate extraction unit 9) which determines words among the acquired words as candidates for a classification name of each item represented by the plurality of item names. The sum over the plurality of item names of the computed relevance of the determined word is up to the top Mth.

The computing means 12 may compute the relevance to the word that composes the item name with that item name as 1, and compute the relevance to the word that does not compose the item name with that item name as 0.

With such a configuration, the item classification assistance system can present candidates for appropriate classification names of the classification for items to be classified to a user.

The acquiring means 11 may acquire from an external source (for example, the product name database) a word that does not compose any of the plurality of item names and that is related to one of the plurality of item names.

The computing means 12 may compute the relevance based on similarity between a plurality of words defined in a dictionary held in advance.

With such a configuration, the item classification assistance system can present candidates for classification names that not be supposed from item names of items to be classified to a user.

The determination means 13 may compute a weight of the word in the plurality of item names for each word, respectively, and determine words among the acquired words as candidates for the classification name. The product of the sum over the plurality of item names of the computed relevance of the determined word and the computed weights is up to the top Mth.

The determination means 13 may compute the weight of the word using the frequency of occurrence of the word in the plurality of item names and the frequency of occurrence of the word in an arbitrarily selected item name.

With such a configuration, the item classification assistance system can present candidates for more appropriate classification names of the classification for items to be classified to a user.

The item classification assistance system 10 may include a display control means (for example, the display control unit 4) which displays a plurality of item names and displays, in a user-specifiable manner, a plurality of candidates for a classification name determined by the determination means 13 for each item represented by the plurality of item names, and a classification determination means (for example, the classification determination unit 6) which determines that the each item is classified by the classification name specified by the user, when any of a plurality of candidates for the classification name is specified by the user.

With such a configuration, the item classification assistance system can assist a user so that the user can determine the classification name of the classification for items to be classified easily.

The display control means may display the item name including a candidate for the classification name together with the candidate for the classification name.

With such a configuration, the user can determine the classification name of the classification for items to be classified more easily.

While the present invention has been explained with reference to the example embodiments, the present invention is not limited to the aforementioned example embodiments. Various changes understandable to those skilled in the art within the scope of the present invention can be made to the structures and details of the present invention.

### INDUSTRIAL APPLICABILITY

The present invention can be suitably applied to an item classification assistance system which assist the item classification.

### REFERENCE SIGNS LIST

1 Item classification assistance system
2 Grouped item name storage unit
3 Classification name candidate determination unit
4 Display control unit
5 Display device
6 Classification determination unit
7 Word matrix generating unit
8 Word matrix correcting unit
9 Classification name candidate extraction unit

What is claimed is:

1. An item classification assistance system comprising:
an acquiring unit which acquires at least one of words from each item name in a group including a plurality of item names;
a computing unit which computes a relevance score for the each item name, the relevance score indicating how the acquired word is related to the each item name; and
a determination unit which assigns at least one of words from the acquired words to a candidate for a classification name of the each item, the assigned at least one of words being assigned based on a pre-determined threshold and sum of the relevance scores for the each item name in the group.

2. The item classification assistance system according to claim 1, wherein
the computing unit computes the relevance score to a word in the item name as 1, and computes the relevance score to a word not in the item name as 0.

3. The item classification assistance system according to claim 1, wherein
the acquiring unit acquires at least one of words from an external source the at least one of words not in any of the plurality of item names but related to one of the plurality of item names.

4. The item classification assistance system according to claim 1, wherein
the computing unit computes the relevance score based on similarity between a plurality of words defined in a pre-determined dictionary.

5. The item classification assistance system according to claim 1, wherein
the determination unit computes a weight of each word in the plurality of item names and assigns at least one of word from the acquired words to a candidate for the classification name, the at least one of words being assigned based on a pre-determined threshold and weighted sum of relevance scores for the each item name in the group, the weighted sum being weighted by the computed weights.

6. The item classification assistance system according to claim 5, wherein
the determination unit computes the weight of word using the frequency of occurrence of word in the plurality of item names and the frequency of occurrence of word in an arbitrarily selected item name.

7. The item classification assistance system according to claim 1, further comprising:
a display control unit which displays a plurality of item names and displays, in a user-specifiable manner, a plurality of candidates for a classification name determined by the determination unit for each item represented by the plurality of item names; and
a classification determination unit which assigns a specified classification name to the each item, when any of a plurality of candidates for the classification name is specified by the user.

8. The item classification assistance system according to claim 7, wherein
the display control unit displays the item name including the word that is a candidate for the classification name together with the candidate for the classification name.

9. An item classification assistance method, implemented by a computer, comprising:
acquiring at least one of words from each item name in a group including a plurality of item names;
computing a relevance score for the each item name, the relevance score indicating how the acquired word is related to the each item name; and
assigning at least one of words from the acquired words to a candidate for a classification name of each item, the assigned at least one of words being assigned based on a pre-determined threshold and sum of relevance scores for the each item name in the group.

10. A computer-readable recording medium recording an item classification assistance program causing a computer to execute:
an acquisition process of acquiring at least one of words from each item name in a group including a plurality of names;
a computation process of computing a relevance score for the each item name, the relevance score indicating how the acquired word is related to the each item name; and
an assignment process of assigning at least one of words from the acquired words to a candidate for a classification name of each item, the assigned at least one of words being assigned based on a pre-determined threshold and sum of relevance scores for the each item name in the group.

11. The item classification assistance system according to claim 2, wherein
the acquiring unit acquires at least one of words from an external source the at least one of words not in any of plurality of item names but related to one of plurality of item names.

12. The item classification assistance system according to claim 2, wherein
the computing unit computes the relevance score based on similarity between a plurality of words defined in a pre-determined dictionary.

13. The item classification assistance system according to claim 3, wherein
the computing unit computes the relevance score based on similarity between a plurality of words defined in a pre-determined dictionary.

14. The item classification assistance system according to claim 11, wherein
the computing unit computes the relevance score based on similarity between a plurality of words defined in a pre-determined dictionary.

15. The item classification assistance system according to claim 2, wherein
the determination unit computes a weight of each word in the plurality of item names, and assigns at least one of word from the acquired words to a candidate for the classification name, the at least one of words being assigned based on a pre-determined threshold and weighted sum of relevance scores for the each item name in the group, the weighted sum being weighted by the computed weights.

16. The item classification assistance system according to claim 3, wherein
the determination unit computes a weight of each word in the plurality of item names, and assigns at least one of word from the acquired words to a candidate for the classification name, the at least one of words being assigned based on a pre-determined threshold and weighted sum of relevance scores for the each item name in the group, the weighted sum being weighted by the computed weights.

17. The item classification assistance system according to claim 4, wherein
the determination unit computes a weight of each word in the plurality of item names, and assigns at least one of word from the acquired words to a candidate for the classification name, the at least one of words being assigned based on a pre-determined threshold and weighted sum of relevance scores for the each item name in the group, the weighted sum being weighted by the computed weights.

18. The item classification assistance system according to claim 11, wherein
the determination unit computes a weight of each word in the plurality of item names, and assigns at least one of word from the acquired words to a candidate for the classification name, the at least one of words being assigned based on a pre-determined threshold and weighted sum of relevance scores for the each item name in the group, the weighted sum being weighted by the computed weights.

19. The item classification assistance system according to claim 12, wherein
the determination unit computes a weight of each word in the plurality of item names, and assigns at least one of word from the acquired words to a candidate for the classification name, the at least one of words being assigned based on a pre-determined threshold and weighted sum of relevance scores for the each item name in the group, the weighted sum being weighted by the computed weights.

20. The item classification assistance system according to claim 13, wherein
the determination unit computes a weight of each word in the plurality of item names, and assigns at least one of word from the acquired words to a candidate for the classification name, the at least one of words being assigned based on a pre-determined threshold and weighted sum of relevance scores for the each item name in the group, the weighted sum being weighted by the computed weights.
